(19) United States
(12) Patent Application Publication
(10) Pub. No.: US 2002/0139684 A1
(43) Pub. Date: Oct. 3, 2002

(54) Plating system, plating method, method of manufacturing semiconductor device using the same, and method of manufacturing printed board using the same

(75) Inventors: Katsuya Kosaki, Tokyo (JP); Takeo Nakamoto, Hyogo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 09/919,875

(22) Filed: Aug. 2, 2001

(30) Foreign Application Priority Data
Apr. 2, 2001 (JP) 2001-103431

(51) Int. Cl. C25D 5/20; C02F 1/40; C25D 21/10; C25B 15/00; C25B 9/00

(52) U.S. Cl. 205/148; 204/237

(57) ABSTRACT

By means of a pump for supplying a plating fluid to a closed plating cup, at least either the pressure or flow rate of the plating fluid circulating within the closed plating cup is cyclically changed. Alternatively, the direction of circulation of the plating fluid circulating within the closed plating cup maybe also changed cyclically. Under a method of manufacturing a semiconductor device or a method of manufacturing a printed board, a semiconductor wafer or a printed board are disposed in the closed plating cup such that blind holes formed by closing openings on one end of via holes or openings on one end of through holes are brought into contact with a circulating plating fluid, thereby eliminating air bubbles that would remain. As a result, a manufacturing yield or performance of a product is improved.

### BACKGROUND OF THE INVENTION

1. Field of the Invention

The present invention relates to a plating system and method for plating a member to be plated through use of a closed-type plating cup, to a method of manufacturing a semiconductor device using the plating system and method, and further to a method of manufacturing a printed board using the plating method and system.

2. Background Art

A semiconductor device is constituted of, for example, a semiconductor substrate made of a group IV compound such as silicon or a group III-V compound such as gallium arsenide (GaAs). Via holes are formed to penetrate through a semiconductor substrate so as to feed power to a semiconductor substrate of a completed semiconductor device or so as to impart the ground potential to the semiconductor substrate. The interior surface of each of the via holes is often plated with gold (Au) or the like. Processes of manufacturing the semiconductor device include a plating process of plating a semiconductor wafer before the wafer is sliced into a plurality of semiconductor chips. In each of the semiconductor chips, a via hole is formed. In the plating process, a plating layer is formed on the interior surface of each of the via holes while one of the ends of each via hole is closed; that is, each of the via holes is held as a blind hole.

In a multilayer printed board, through holes are formed in a printed board. A plating layer of copper (Cu) or the like is formed on the surface of each of the through holes, including an interior surface. The plating layer is used for interlayer connection between layers of a multilayer printed board. In some cases, through holes formed in the printed board are also plated while one end of each of the through holes is closed; that is, the through holes are held in the state of blind holes.

A plating system having a closed plating cup is usually used for effecting the foregoing plating operation. The closed plating cup subjects a semiconductor wafer or a printed board to electrolytic plating, by means of circulating a plating fluid at a certain pressure and at a certain flow rate within a closed internal processing chamber. A member to be plated, such as a semiconductor wafer or a printed board, is disposed within the closed plating cup such that open ends of respective via holes or through holes are oriented faceup. A plating layer is formed on the surface of each of the blind holes, including an interior surface, by means of electrolysis of the plating fluid.

In relation to a plating operation for forming a plating layer on the surface of such a blind hole, including an interior surface, air bubbles arising in the blind hole pose a problem. A faceup style is effective for diminishing the amount of air bubbles arising in a blind hole. However, despite adoption of the faceup style, a problem of air bubbles still remains unsolved. Particularly when the aspect ratio of a blind hole becomes higher such that hole depth becomes greater than hole diameter, occurrence of air bubbles in a blind hole cannot be avoided. If air bubbles remain in the same location, a plating fluid fails to come into contact with a portion of the interior surface corresponding to the location. Consequently, failures arise in the plating layer. The plating failures result in disconnection of a plating layer or an increase in electric resistance. In turn, this accounts for a drop-off in manufacturing yield or for deterioration of performance of a completed semiconductor device or printed board.

### SUMMARY OF THE INVENTION

The present invention proposes a plating system and a plating method which have been improved so as to be able to prevent occurrence of plating failures.

The present invention proposes a method of manufacturing an improved semiconductor device and a method of manufacturing a printed board, which methods are improved so as to be able to hamper occurrence of plating failures.

According to one aspect of the present invention, a plating system comprises a closed plating cup, a reservoir tank and a pump for supplying the plating fluid. The closed plating cup plates a member to be plated by means of circulating a plating fluid in the cup at a certain pressure and flow rate. The reservoir tank stores the plating fluid.

The pump supplies the plating fluid from the reservoir tank to the closed plating cup, and the pump cyclically changes at least the pressure or flow rate of the plating fluid in the closed plating cup.

In another aspect of the present invention, the pump supplies the plating fluid from the reservoir tank to the closed plating cup, and the direction of circulation of the plating fluid in the closed plating cup is cyclically changed.

According to another aspect of the present invention, the closed plating cup has first and second plating circulation ports. The pump comprises first and second pumps. The first pump circulates a plating fluid within the closed plating cup from the first plating fluid circulation port to the second plating fluid circulation port, and the second pump circulates the plating fluid from the second plating fluid circulation port to the first plating fluid circulation port.

Other and further objects, features and advantages of the invention will appear more fully from the following description.

### BRIEF DESCRIPTION OF THE DRAWINGS

FIG. 1 is a view showing the overall configuration of a plating system according to the present invention.

FIG. 2 shows an example of a configuration of a closed plating cup in the present invention.

FIG. 3 shows a partial enlarged view of FIG. 2 at a portion of a ring-shaped seal member.

FIGS. 4(a) and 4(b) show a plating layer formation step of a plating method of the present invention.

FIGS. 5(a) through 5(d) show an another embodiment of plating layer formation step in the present invention.

FIG. 6 is a view showing the overall configuration of a plating system according to a third embodiment of the present invention.

FIG. 7 is a view showing the overall configuration of a plating system according to a fourth embodiment of the present invention.

FIG. 8 is a view showing the overall configuration of a plating system according to a fifth embodiment of the present invention.

### DETAILED DESCRIPTION OF THE PREFERRED EMBODIMENTS

First Embodiment

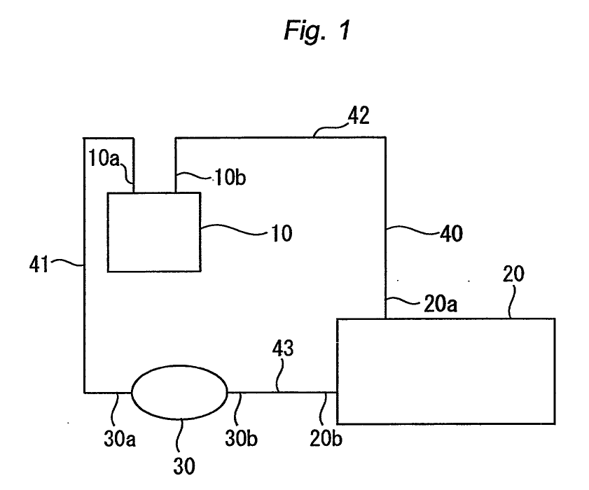

FIG. 1 is a view showing the overall configuration of a plating system according to the present invention. The plating system comprises a closed plating cup 10; a reservoir tank 20 for reserving a plating fluid; a pump 30 for supplying a plating fluid to the closed plating cup 10; and a plating fluid circulation path 40 including the plating cup 10, the reservoir tank 20, and the pump 30.

The closed plating cup 10 is provided with a set of plating fluid circulation ports 10a and 10b in communication with an internal processing chamber of the cup 10. Here, the plating fluid circulation port 10a constitutes a plating fluid supply port, and the plating fluid circulation port 10b constitutes a plating fluid outlet port. The reservoir tank 20 has a plating fluid inlet port 20a and a plating fluid outlet port 20b. Further, the pump 30 has a plating fluid outlet port 30a and a plating port inlet port 30b. The plating fluid outlet port 30a of the pump 30 is connected to the plating fluid supply port 10a of the closed plating cup 10 by means of a pipe 41. The pipe 41 constitutes a channel for supplying a plating fluid to the closed plating cup 10. The plating fluid outlet port 10b of the closed plating fluid cup 10 is connected to the plating fluid inlet port 20a of the reservoir tank 20 by means of the pipe 42. The pipe 42 constitutes a plating fluid outlet channel of the closed plating cup 10. The plating fluid outlet port 20b of the reservoir tank 20 is connected to the inlet port 30b of the pump 30.

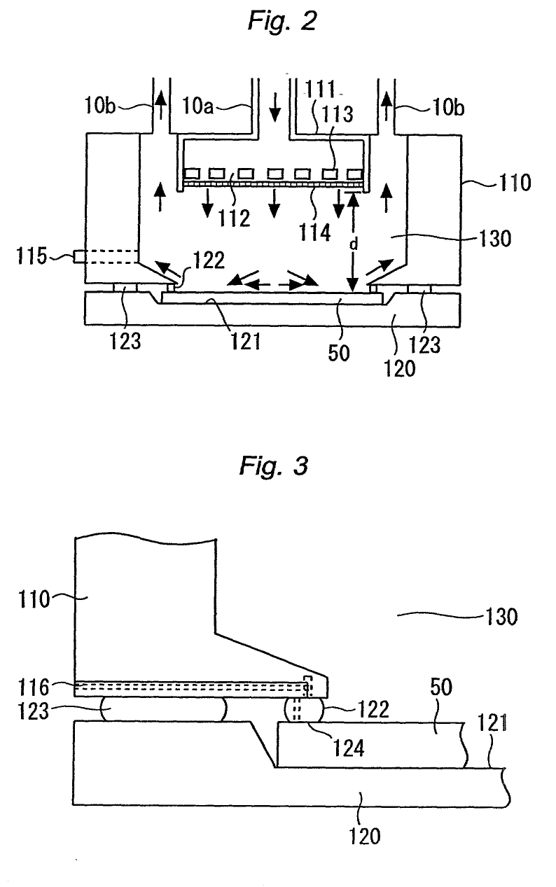

FIG. 2 shows an embodiment of the closed plating cup 10. The closed plating cup 10 has an upper cup 110 and a lower cup 120. The upper cup 110 and the lower cup 120 constitute a closed processing chamber 130. A lower portion of the upper cup 110 is opened, and the plating fluid circulation port 10a is provided in substantially the upper center of the upper cup 110. Further, the plating fluid circulation port 10b is provided on either side of the plating fluid circulation port 10a. A plating fluid squirting section 111 is formed from a cylindrical member having an opened lower portion. A plating fluid squirting plate 113 having a plurality of plating fluid squirting holes 112 is provided at the open end of the plating fluid squirting section 111. Further, the plating fluid squirting plate 113 has a mesh anode electrode 114. A drain pipe 115 is provided in a lower portion of the upper cup 110 for collecting plating fluid or discharging wash water. The lower end of the plating fluid squirting section 111 is spaced away from and disposed opposite a top surface of a member 50 to be plated, with an interstice “d” provided therebetween. The hydraulic pressure within the cup 10 can be changed by means of changing the interstice “d.”

The lower cup 120 is formed in the shape of a plate and is combined with the upper cup 110 so as to close the bottom of the upper cup 110. A depression 121 on which the member 50 is to be mounted is formed in the center of the lower cup 120. The member 50 is, for example, a semiconductor wafer or a printed board. A ring-shaped seal member 122 is provided between an outer periphery of an upper surface of the member 50 and the bottom surface of the upper cup 110, thereby sealing the processing chamber 130 so as to prevent leakage of plating fluid from theprocessingchamber130. A similar ring-shaped auxiliary seal member 123 is provided around and outside the seal member 122. The auxiliary seal member 123 is sandwiched between the bottom surface of the upper cup 110 and the lower cup 120.

As shown in FIG. 3 in an enlarged manner, the ring-shaped seal member 122 is provided with a cathode contact 124. The cathode contact 124 is a needle or wire provided so as to penetrate through the ring-shaped seal member 122 in a plurality of locations. The cathode contact 124 is in point contact with the member 50, thereby imparting a cathode potential to the member 50. Although a d.c. power supply to be used for plating is not illustrated, the anode of the d.c. power supply is connected to the mesh anode electrode 114, and the cathode of the d.c. power supply is connected to the cathode contact 124. A release 116 of the seal member 122 for squirting a gas or pure water is provided on the bottom of the upper cup 110. The release 116 is in communication with a supply source of gas or pure water.

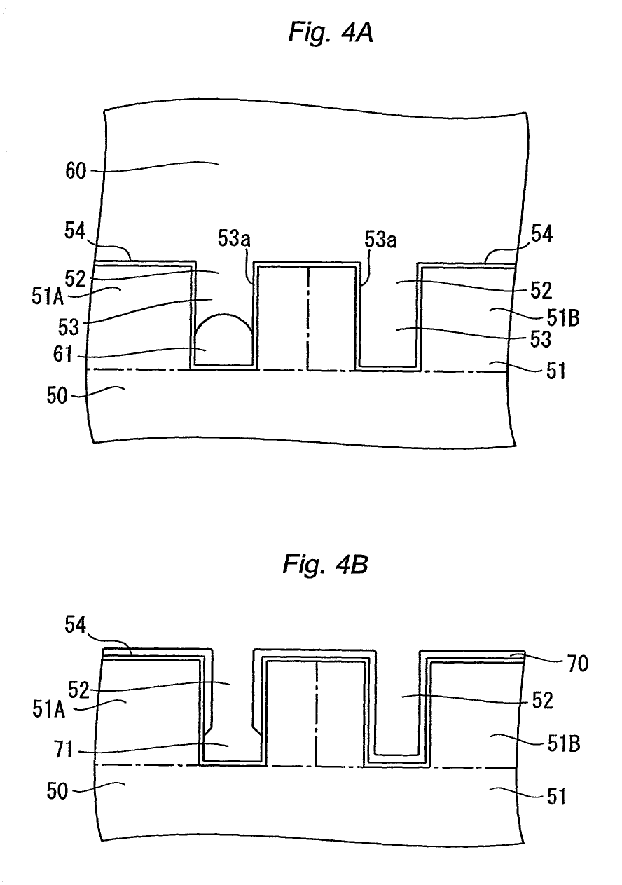

FIGS. 4(a) and 4(b) show a plating layer formation step of a plating method for plating the member 50 through use of the plating system according to the first embodiment, to thereby form a plating layer. FIGS. 4(a) and 4(b) also show a plating process of a method of manufacturing a semiconductor device. The member 50 which is to undergo the plating process corresponds to, e.g., a semiconductor wafer. The member 50 includes a semiconductor substrate 51 formed from, e.g., silicon or gallium arsenide. The semiconductor substrate 51 includes a plurality of semiconductor substrate portions. FIGS. 4(a) and 4(b) show two semiconductor substrate sections 51A and 51B separated from each other by means of a phantom line. In a completed semiconductor device, the semiconductor substrate portions 51A and 51B are separated individually from each other along the phantom line. The thus-separated semiconductor substrate portions 51Aand 51B are to become semiconductor substrates of respective semiconductor devices, the substrates being called chips. Reference numeral 60 designates a plating fluid.

In relation to the semiconductor wafer 50, a blind hole 53 which is to become a via hole is formed in each of the semiconductor substrate portions 51A and 51B. The semiconductor wafer 50 undergoes plating while a lower end of each of the blind holes 51 is closed and an upper end of each of the blind holes 51 is opened. The semiconductor wafer 50 is disposed in a processing chamber 130 of the closed plating cup 10 such that an upper open end of each of the blind holes 53 is oriented upward and comes into contact with the circulating plating fluid 60. The manner in which the semiconductor wafer 50 is disposed such that the upper end of each of the blind holes 53 is oriented up is called the faceup style.

As compared with a facedown style in which the open end of each of the blind holes 53 is oriented downward, the faceup style is more effective for diminishing the amount of air bubbles developing in each of the blind holes 53 during a plating operation. In the facedown style, the closed opening of each of the blind holes 53 is oriented upward, and hence there is a high risk of air bubbles being captured in the blind holes 53.

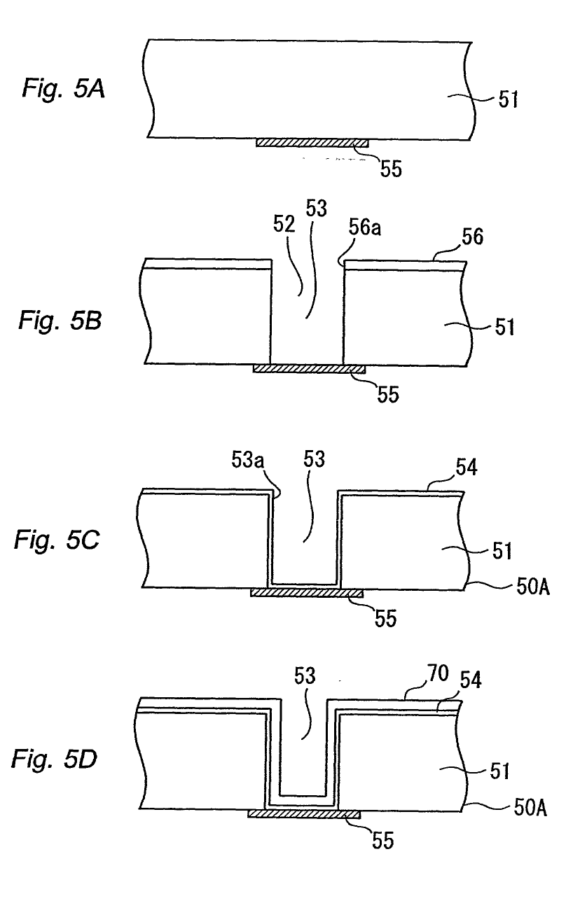

A thin feeding layer 54 is formed beforehand on the top of the semiconductor wafer 50, including interior surfaces 53a of the blind holes 53. A cathode potential is applied to the feeding layer 54 from the cathode contact 124. Consequently, a plating layer 70 is formed on the feeding layer 54. After completion of the plating operation, the bottom of the semiconductor wafer 50 is eliminated by means of, e.g., abrasion, until the respective via holes 52 become through holes. As shown in FIGS. 5(a) through 5(d), when via holes are formed after the semiconductor wafer 50 has been made thin, the semiconductor wafer 50 is made thin before formation of via holes through abrasion.

Even in the faceup plating system, air bubbles 61 sometime develop and remain in the blind holes 53. In relation to the semiconductor wafer 50 in which via holes having a high aspect ratio are formed, the width of the blind hole 53 becomes smaller and the depth of the same becomes greater. Hence, there is increased the risk of the air bubbles 61 developing and remaining in the blind holes 53. In FIG. 4(a), an air bubble 61 develops in a left-side blind hole 53. If the air bubble 61 remains during a plating operation, a plating failure 71 arises, as shown in FIG. 4(b).

When a plating layer 70 made of gold (Au) is formed on the semiconductor wafer 50 formed from GaAs, a sulfurous-acid-based plating fluid or a cyan-based plating fluid is used as the plating fluid 60. For instance, the sulfurous-acid-based plating fluid is composed primarily of gold sodium sulfite and sodium sulfite. The cyan-based plating fluid is composed primarily of gold cyanide sulfite. During a plating operation, the plating fluid 60 assumes a temperature ranging from 40(C to 70(C; for example, a recommended temperature of 50(C or 65(C. The dynamic viscosity of the plating fluid 60 assumes a value of, e.g., 0.6 to 0.8 m2/sec.

The closed plating cup 10 is effective for imparting a certain pressure and flow rate to a plating fluid in the processing chamber 130 of the cup 10. Use of the closed plating cup 10 enables a reduction in the amount of air bubbles 61 developing and remaining in the blind holes 53. Pressure applied to the plating fluid in the processing chamber 130 provided in the closed plating cup 10 is set to a high value of, e.g., 1000 Pa or greater. Such a high pressure is effective for reducing the likelihood of the air bubbles 61 arising and remaining in the blind holes 53.

In the first embodiment, a pulsating pump is used as the pump 30 for supplying a plating fluid to the processing chamber 130 of the closed plating cup 10. More specifically, a bellows pump or a diaphragm pump is used as the pulsating pump 30. A bellows pump pumps a plating fluid into the processing chamber 130 of the closed plating cup 10 by means of pulsating action of a bellows. The pressure and flow rate of the plating fluid within the processing chamber 130 change cyclically in accordance with the cycle of pulsating action. Similarly, even in the case of a diaphragm pump, the pressure and flow rate of the plating fluid within the processing chamber 130 change cyclically in accordance with pulsating action of a diaphragm. In a bellows pump or a diaphragm pump, the pressure of the plating fluid in the processing chamber 130 changes in a pulse-like manner in accordance with a cycle of pulsating action.

The plating system and the plating method, in which a pulsating pump is used as the pump 30 to thereby cyclically change the pressure and flow rate of a plating fluid in the processing chamber 130, are effective for diminishing the likelihood of the air bubbles 61 developing and remaining in the blind holes 53. The air bubble 61 remaining means that the developed air bubble 61 remains in the same location during a plating operation. Cyclic changes in the pressure and flow rate of the plating fluid in the processing chamber 130 ascribable to the pulsating pump 30 are effective for moving the air bubble 61 from the location where it has developed and for preventing the air bubble 61 from remaining in the same location. The method of manufacturing a semiconductor device according to the present invention lessens the likelihood of plating failures, which in turn improves a manufacturing yield of a semiconductor device to be manufactured by way of the plating process or improves the performance of a semiconductor device.

More specifically, a bellows pump is used as the pump 30, and the pressure applied to the plating fluid at the outlet port 30a is set to a value of 0.12 MPa (mega pascals). Further, a plating fluid is circulated at a flow rate of 13 liters/min. When the pulsating cycle of the bellows pump is set to 68 shots/min., plating failures ascribable to the air bubbles 61 remaining can be solved completely. The pressure of the plating fluid in the processing chamber 130 is dependent on the interstice “d” shown in FIG. 2; namely, the length of an interstice between the lower end of the plating fluid squirting section 11 and the member 50 to be plated. Hence, the interstice “d” is set to the value ranging from 5 to 6 millimeters.

Second Embodiment

A plating method according to the present invention is shown in sequential order of steps. The plating system described in connection with the first embodiment is used in the plating method.

The second embodiment shows plating processes of the method of manufacturing a semiconductor device. The second embodiment employs a semiconductor wafer 50A in which one end of each of the blind holes 53 is partially covered with a cover member. FIGS. 5(a) through 5(d) show processes of producing the semiconductor wafer 50A having such blind holes 53; namely, processes ranging from a plating preparation process to a plating process.

FIG. 5(a) shows a first preparation step. In this step, cover members 55 formed from gold (Au) are bonded to a lower surface—namely, at predetermined areas on the back surface—of the semiconductor substrate 51, which is formed from, e.g., gallium arsenide (GaAs), and has a thickness ranging from 30 micrometers to 150 micrometers. The cover members 55 are attached to respective positions in which via holes 52 are to be formed. FIG. 5(b) shows a second preparation step, wherein a resist film 56 is formed on the upper surface of the semiconductor substrate 51. Openings 56a are formed at positions on the resist film 56 where the via holes 52 are to be formed. The semiconductor wafer 50A is etched in this state, whereby the via holes 52 are formed. The via holes 52 are formed so as to penetrate through the semiconductor substrate 51. Lower-end openings of the respective via holes 52 are closed by the cover members 55, thereby constituting the blind holes 53. FIG. 5(c) shows a third preparation step, in which the resist film 56 is removed and a thin feeding layer 54 is formed on the upper surface of the semiconductor substrate 51, including interior surfaces 53a of the blind holes 53. The feeding layer 54 corresponds to a thin film which is formed from, e.g., nickel (Ni)/gold (Au), titanium (Ti)/gold (Au), or chromium (Cr)/gold (Au), by means of sputtering or electroless plating.

FIG. 5(d) shows a plating process. A plating layer 70 made of, e.g., gold (Au), is formed in the processing chamber 130 of the closed plating cup 10. During the plating process, the semiconductor substrate 51 is plated while the openings of the blind holes 53 are oriented upward and remain in contact with the plating fluid circulating through the processing chamber 130. A pulsating pump is used as the pump 30, and the pressure and flow rate of the plating fluid in the processing chamber 130 vary in accordance with a pulsating cycle of the pulsating pump, thereby preventing any air bubbles 61 from remaining.

A method of manufacturing a printed board is also identical with that shown in FIGS. 5(a) through 5(d). A printed board is formed from a dielectric board. A predetermined circuit pattern is formed from a copper layer on each of a pair of principal planes. Simultaneously, through holes are formed in predetermined areas so as to penetrate through the dielectric board. With the through holes being taken as blind holes, the printed board is plated in the same manner as shown in FIG. 5(d). Eventually, plating layers provided on the interior surfaces of the through holes electrically interconnect predetermined circuit patterns provided on the respective principal planes. More specifically, the printed board is plated in the processing chamber 130 of the closed plating cup 10 while being oriented upward, such that the through holes formed in the board are opened at one end and closed at the other end, like the blind hole shown in FIG. 5(c). Any air bubbles that remain in the blind holes are effectively discharged by means of pulsating action of the pump 30, thereby lessening the likelihood of plating failures. By means of the method for lessening the likelihood of plating failures, a manufacturing yield of a print board is improved, or the performance of a printed board is improved.

Third Embodiment

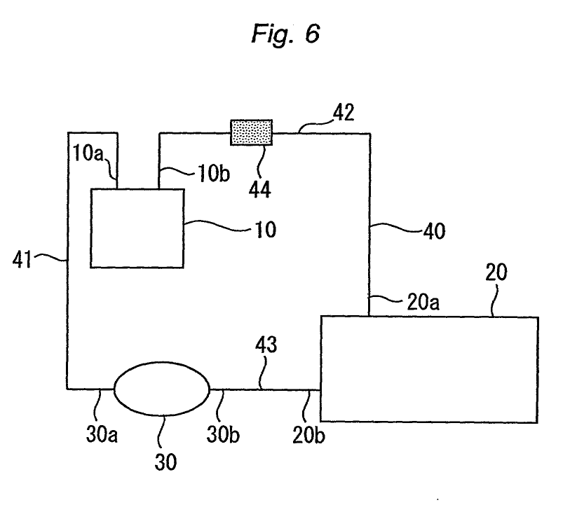

FIG. 6 is a view showing the overall configuration of a plating system according to a third embodiment of the present invention. The plating system according to the third embodiment is used for the plating method according to the present invention. Further, the plating system is employed in plating processes of the method of manufacturing a semiconductor device and in those of the method of manufacturing a printed board, both pertaining to the present invention. In the third embodiment, further improvements are made to the plating system according to the first embodiment shown in FIG. 1. Elements which are the same as those shown in FIG. 1 are assigned the same reference numerals. In the third embodiment, a flow-rate throttle valve 44 is attached to the plating fluid circulation port 10b of the closed plating cup 10; that is, a plating fluid outlet port.

The flow-rate throttle valve 44 limits the flow rate of plating fluid flowing through the plating fluid outlet port 10b of the closed plating processing cup 10, thereby increasing the internal pressure of the processing chamber 130 of the closed plating processing cup 10. The flow-rate throttle valve 44 facilitates adjustment of the pressure of plating fluid in the processing chamber 130 to a higher level. Thus, the flow-rate throttle valve 44 is effective for preventing occurrence of plating failures, which would otherwise be caused by trapped air. The flow-rate throttle valve 44 is not limited to the plating fluid outlet port 10b but may also be provided at the pipe 43 for interconnecting the placing cup 10 and the fluid reservoir tank 20. Here, as the throttle valve 44 is disposed closer to the plating fluid outlet port 10b, the plating-failure prevention effect becomes greater.

Fourth Embodiment

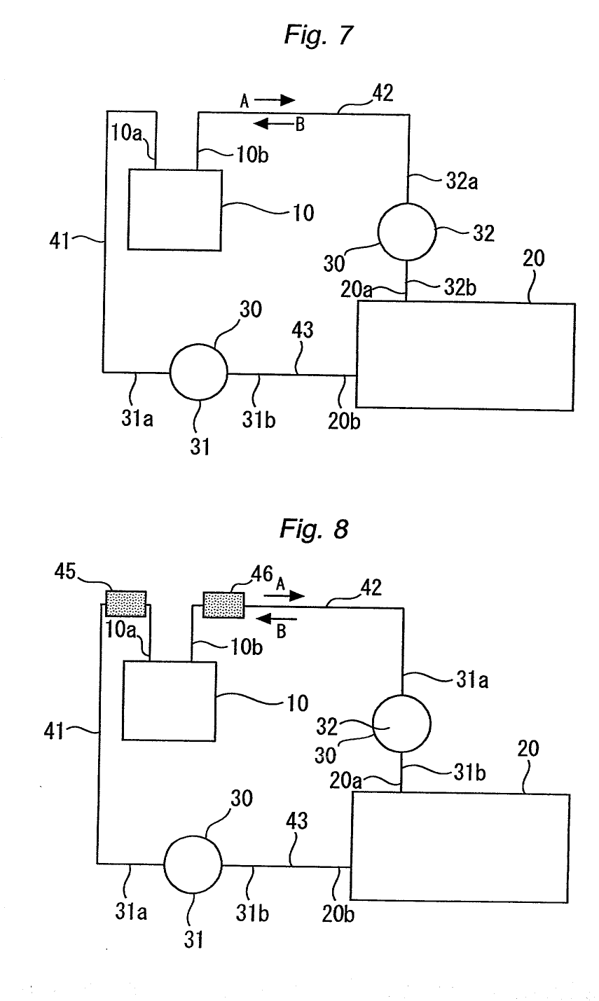

FIG. 7 is a view showing the overall configuration of a plating system according to a fourth embodiment of the present invention. The plating system according to the fourth embodiment is used for the plating method according to the present invention. Further, the plating system is employed in plating processes of the method of manufacturing a semiconductor device and in those of the method of manufacturing a printed board, both pertaining to the present invention. In the fourth embodiment, two pumps 31 and 32 are used as the pump 30 for supplying a plating fluid to the closed plating cup 10. Both the pumps 31 and 32 are of non-pulsating type. More specifically, the pumps 31 and 32 correspond to dubbed magnet pumps. The magnet pump rotates a rotor by the same principle as that by which a motor rotates, thereby applying pressure to a plating fluid so as to continuously squirt the plating fluid. In contrast to a pulsating pump, outlet ports 31a and 32a continuously squirt a plating fluid. Here, reference numeral 31b designates an inlet port of the pump 31, and 32b designates an inlet port of the pump 32.

The pumps 31 and 32 are connected so as to supply a plating fluid to the processing chamber 130 of the closed plating cup 10 in opposite directions. Specifically, the outlet port 31a of the pump 31 is connected to the plating fluid circulation port 10a by means of the pipe 41, and the outlet port 32a of the pump 32 is connected to the plating fluid circulation port 10b by means of the pipe 42. Consequently, when the pump 31 is actuated, the plating fluid is circulated through the processing chamber 130 in the direction designated by arrow A from the plating fluid circulation port 10a to the plating fluid circulation port 10b. Further, when the pump 32 is actuated, the plating fluid is circulated through the processing chamber 130 in the direction designated by arrow B from the plating fluid circulation port 10b to the plating fluid circulation port 10a.

The pumps 31 and 32 are actuated alternately and intermittently. When the pump 31 is actuated, the pump 32 remains inoperative. Similarly, when the pump 32 is actuated, the pump 31 remains inoperative. Consequently, the direction in which the plating fluid is circulated in the processing chamber 130 is cyclically reversed. Reversing the direction of circulation of the plating fluid results in varying the pressure and flow rate of a plating fluid which circulates while remaining in contact with the blind holes 53 of the member 50 and is effective for preventing occurrence of air bubbles in the blind holes 53 and air bubbles remaining in the same. Provided that one direction of circulation of a plating fluid is taken as positive, the direction of circulation of a plating fluid in the processing chamber 130 is switched such that the pressure and flow rate of the plating fluid vary greatly from a positive value to a negative value. Hence, switching of the direction of circulation of a plating fluid is effective for discharging air bubbles from the blind holes 53.

Fifth Embodiment

FIG. 8 is a view showing the overall configuration of a plating system according to a fifth embodiment of the present invention. The plating system according to the fifth embodiment is used for the plating method according to the present invention. Further, the plating system is employed in plating processes of the method of manufacturing a semiconductor device and in those of the method of manufacturing a printed board, both pertaining to the present invention. In the fifth embodiment, further improvements are made to the plating system according to the fifth embodiment shown in FIG. 7. Elements which are the same as those shown in FIG. 7 are assigned the same reference numerals. In the fifth embodiment, the plating fluid circulation port 10a of the closed plating cup 10 is equipped with a flow-rate control valve 45, and the plating fluid circulation port 10b is equipped with a flow-rate control valve 46. For instance, the flow-rate control valves 45 and 46 are electromagnetic control valves and can control a flow rate electrically. In synchronism with alternate actuation of the pumps 31 and 32, the flow-rate control valves 45 and 46 control a flow rate.

When the pump 31 is actuated, the flow-rate control valve 46 attached to the circulation port 10b is taken as a flow-rate throttle valve, thereby increasing the pressure of the plating fluid circulation port 10b by way of which a plating fluid is drained from the processing chamber 130. In contrast, when the pump 32 is actuated, the flow-rate control valve 45 attached to the circulation port 10a is taken as a flow-rate throttle valve, thereby increasing the pressure of the plating fluid circulation port 10b by way of which a plating fluid is drained from the processing chamber 130. The flow-rate control valves 44 and 45 facilitate adjustment of a plating fluid in the processing chamber 130 at a higher pressure. Air bubbles are effectively discharged from the blind holes 53 by means of switching the direction of circulation of the plating fluid.

The appended claims of this application are directed to a plating system for plating a member through use of a closed-type plating cup. However, the present invention includes a method for plating a member through use of a plating system using a closed-type plating cup as follows.

According to one aspect of the present invention, a plating method under which a member to be plated having a plurality of blind holes, openings on one side of the blind holes being opened and openings on the other side of the same being closed, is plated such that the surface of the member, including interior surfaces of the respective blind holes, is plated, wherein the member is disposed in the closed plating cup such that openings on one side of the respective blind holes are in contact with a plating fluid by means of circulating the plating fluid within the closed plating cup at a certain pressure and flow rate, and at least either the pressure or flow rate of the plating fluid circulating within the closed plating cup is changed cyclically. (#12)

According to another aspect of the present invention, a plating method under which a member to be plated having a plurality of blind holes, openings on one side of the blind holes being opened and openings on the other side of the same being closed, is plated such that the surface of the member, including interior surfaces of the respective blind holes, is plated, wherein the member is disposed in the closed plating cup such that openings on one side of the respective blind holes are in contact with a plating fluid by means of circulating the plating fluid within the closed plating cup at a certain pressure and flow rate, and the direction of circulation of the plating fluid circulating through the closed plating cup is changed cyclically. (#13)

According to another aspect of the present invention, a method of manufacturing a semiconductor device having via holes penetrating through a semiconductor substrate, comprising: a plating step of plating the surface of the semiconductor substrate, including interior surfaces of the via holes, wherein the plating step involves circulation of a plating fluid within a closed plating cup at a certain pressure and flow rate, disposition of the semiconductor wafer including the semiconductor substrate in the closed plating cup such that openings on one side of the via holes are opened and openings on the other side of the via holes are closed and such that the opened openings are in contact with the plating fluid, and cyclic change in at least the pressure or flow rate of the plating fluid circulating within the closed plating cup. (#14)

According to another aspect of the present invention, a method of manufacturing a semiconductor device having via holes penetrating through a semiconductor substrate, comprising: a plating step of plating the surface of the semiconductor substrate, including interior surfaces of the via holes, wherein the plating step involves circulation of a plating fluid within a closed plating cup at a certain pressure and flow rate, disposition of the semiconductor wafer including the semiconductor substrate in the closed plating cup such that openings on one side of the via holes are opened and openings on the other side of the via holes are closed and such that the opened openings are in contact with the plating fluid, and cyclic change in the direction of circulation of the plating fluid circulating within the closed plating cup. (#15)

According to another aspect of the present invention, a method of manufacturing a printed board having through holes penetrating through a board, comprising: a plating step of plating the surface of the board, including interior surfaces of the through holes, wherein the plating step involves circulation of a plating fluid within a closed plating cup at a certain pressure and flow rate, disposition of the board in the closed plating cup such that openings on one side of the through holes are opened and openings on the other side of the through holes are closed and such that the opened openings are in contact with the plating fluid, and cyclic change in at least the pressure or flow rate of the plating fluid circulating within the closed plating cup. (#16)

According to another aspect of the present invention, a method of manufacturing a printed board having through holes penetrating through a board, comprising: a plating step of plating the surface of the board, including interior surfaces of the through holes, wherein the plating step involves circulation of a plating fluid within a closed plating cup at a certain pressure and flow rate, disposition of the board in the closed plating cup such that openings on one side of the through holes are opened and openings on the other side of the through holes are closed and such that the opened openings are in contact with the plating fluid, and cyclic change in the direction of circulation of the plating fluid circulating within the closed plating cup. (#17)

The features and advantages of the present invention may be summarized as follows.

As has been described, the plating system according to the present invention has the closed plating cup which plates a member to be plated by means of circulating a plating fluid in the plating system at a certain pressure and flow rate. The pump for supplying a plating fluid to the closed plating cup cyclically changes at least either a pressure or flow rate of a plating fluid in the closed plating cup. Hence, the plating system yields an advantage of the ability to lessen the likelihood of air bubbles remaining on the member and the likelihood of plating failures ascribable to air bubbles that remain.

The pump is constituted of a pulsating pump, and the pulsating pump is constituted of a bellows pump or a diaphragm pump. A plating fluid is supplied to the closed plating cup by means of pulsating action of the pump, thereby cyclically changing at least either a pressure or flow rate of the plating fluid circulating through the inside of the closed plating cup. At least either a pressure of flow rate of the plating fluid circulating through the inside of the closed plating cup is effectively changed by means of the pulsating pump. Hence, there is yielded an advantage of the ability to lessen the amount of air bubbles remaining on a member to be plated and the likelihood of plating failures ascribable to air bubbles that remain.

In the case of the plating system equipped with a flow-rate throttle valve attached to a channel by way of which a plating fluid is discharged from the closed plating cup, the pressure of a plating fluid circulating through the inside of the closed plating cup can be adjusted at a higher level. There is yielded an advantage of the ability to effectively lessen the amount of air bubbles that remain on the member and the likelihood of air bubbles remaining, by means of cyclic changes in at least either a pressure or flow rate of a plating fluid.

When the direction of circulation of a plating fluid circulating through the inside of the closed plating cup is cyclically changed, the flow rate of the plating fluid as well as the direction of the same is changed greatly. Hence, there is yielded an advantage of the ability to effectively lessen the amount of air bubbles that remain on the member and the likelihood of plating failures ascribable to air bubbles that remain.

When the direction of circulation of a plating fluid in the closed plating cup is cyclically changed through use of two pumps, the direction of circulation of a plating fluid can be changed effectively. A flow-rate control valve is provided in each of the plating fluid circulation channels of the closed cup plating cup. In association with switching between the two pumps, the flow-rate control valve connected to a channel by way of which a plating fluid is to be discharged is taken as a flow-rate throttle valve. As a result, the pressure of a plating fluid in the closed plating cup can be adjusted at a higher level. There is yielded an advantage of the ability to effectively lessen the amount of air bubbles that remain on the member, by means of cyclic changes in at least either the pressure or flow rate of a plating fluid, thereby diminishing the likelihood of plating failures ascribable to air bubbles that remain.

The member to be plated has a plurality of blind holes and is disposed in the closed plating cup such that openings of the blind holes remain in contact with a plating fluid. A plating layer is formed on the surface of the member, including interior surfaces of the blind holes. As a result, air bubbles that remain in the blind holes are effectively prevented, thereby lessening the likelihood of plating failures ascribable to air bubbles that remain. A plating layer is formed on a semiconductor wafer having via holes, the via holes being closed at one end thereof, or on a printed board having via holes, the via holes being closed at one end thereof. Similarly, the amount of air bubbles that remain in via holes or through holes is diminished, thereby lessening the likelihood of plating failures ascribable to air bubbles that remain.

The plating method according to the present invention is for plating a member to be plated having a plurality of blind holes. The member is disposed in the closed plating cup such that openings of the blind holes remain in contact with a plating fluid. The method involves cyclic changes in at least either the pressure or flow rate of a plating fluid in the closed plating cup. There is yielded an advantage of the ability to lessen air bubbles that remain on the member, thereby diminishing the likelihood of plating failures ascribable to air bubbles that remain.

The plating method including cyclic switching of the direction of circulation of a plating fluid within a closed plating cup yields an advantage of the ability to greatly change the flow rate of a plating fluid as well as the direction of circulation of the same, thereby effectively diminishing the amount of air bubbles that remain on the member and lessening the likelihood of plating failures ascribable to air bubbles that remain.

The method of manufacturing a semiconductor device according to the present invention includes a plating step of forming a plating layer on the surface of the member, including interior surfaces of a plurality of via holes. The plating step includes disposition of the member in the closed plating cup such that openings on one side of respective via holes are in contact with a plating fluid, and cyclic changes in at least either the pressure or flow rate of a plating fluid in the closed plating cup. The plating method diminishes the amount of air bubbles that remain on the member, thereby lessening the likelihood of plating failures ascribable to air bubbles that remain. Further, the plating method involving cyclic changes in the direction of circulation of a plating fluid in the closed plating cup enables a great change in the flow rate of a plating fluid as well as in the direction of circulation of the same, thereby effectively diminishing the amount of air bubbles that remain on the member and lessening the likelihood of plating failures ascribable to air bubbles that remain. Further, the method enables improvements in the performance of a semiconductor device as well as in manufacturing yield of the same.

The method of manufacturing a printed board according to the present invention includes a plating step of forming a plating layer on the surface of the board, including interior surfaces of a plurality of via holes. The plating step includes disposition of the board in the closed plating cup such that openings on one side of respective through holes are in contact with a plating fluid, and cyclic changes in at least either the pressure or flow rate of a plating fluid in the closed plating cup. The plating method diminishes the amount of air bubbles that remain on the member, thereby lessening the likelihood of plating failures ascribable to air bubbles that remain. Further, the plating method involving cyclic changes in the direction of circulation of a plating fluid in the closed plating cup enables a great change in the flow rate of a plating fluid as well as in the direction of circulation of the same, thereby effectively diminishing the amount of air bubbles that remain on the member and lessening the likelihood of plating failures ascribable to air bubbles that remain. Further, the method enables improvements in the performance of a printed board as well as in manufacturing yield of the same.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2001-103431, filed on Apr. 2, 2001 including specification, claims, drawings and summary, on which the Convention priority of the present application is based, are incorporated herein by reference in its entirety.

What is claimed is:

1. A plating system comprising:
a closed plating cup which plates a member to be plated by means of circulating a plating fluid in the cup at a certain pressure and flow rate;
a reservoir tank for storing the plating fluid; and
a pump for supplying the plating fluid from the reservoir tank to the closed plating cup, wherein the pump cyclically changes at least the pressure or flow rate of the plating fluid in the closed plating cup.

2. The plating system according to claim 1, wherein the pump is constituted of a pulsating pump, and the pulsating pump cyclically changes at least either the pressure or flow rate of the plating fluid circulating within the closed plating cup.

3. The plating system according to claim 2, wherein the pulsating pump is constituted of a bellows pump, and the bellows pump cyclically pulsates the bellows, to thereby supply the plating fluid to the closed plating cup and to cyclically change at least either the pressure or flow rate of the plating fluid circulating within the closed plating cup.

4. The plating system according to claim 2, wherein the pulsating pump is constituted of a diaphragm pump, and the diaphragm of the diaphragm pump is cyclically pulsated, to thereby supply the plating fluid to the closed plating cup and to cyclically change at least either the pressure or flow rate of the plating fluid circulating within the closed plating cup.

5. The plating system according to claim 1, comprising a supply channel for supplying the plating fluid to the closed plating cup, a drain channel for discharging the plating fluid from the closed plating cup, and a flow-rate throttle valve provided in the drain channel for discharging the plating fluid.

6. A plating system comprising:
a closed plating cup which plates a member to be plated by means of circulating a plating fluid in the cup at a certain pressure and flow rate;
a reservoir tank for storing the plating fluid; and
a pump for supplying the plating fluid from the reservoir tank to the closed plating cup, wherein the direction of circulation of the plating fluid in the closed plating cup is cyclically changed.

7. The plating system according to claim 6, wherein the closed plating cup has first and second plating circulation ports; the pump comprises first and second pumps; the first pump circulates a plating fluid within the closed plating cup from the first plating fluid circulation port to the second plating fluid circulation port; and the second pump circulates the plating fluid from the second plating fluid circulation port to the first plating fluid circulation port.

8. The plating system according to claim 7, comprising:
a first plating fluid circulation channel communicating with the first plating fluid circulation port of the closed plating cup;
a second plating fluid circulation channel communicating with the second plating fluid circulation port of the closed plating cup;
a first flow-rate control valve provided in the first plating fluid circulation channel; and
a second flow-rate control valve provided in the second plating fluid circulation channel, wherein, when the plating fluid flows from the first plating fluid circulation port to the second plating fluid circulation port, the second flow-rate control valve provided in the second plating fluid circulation channel communicates with the second plating fluid circulation port; and, when the plating fluid flows from the second plating fluid circulation port to the first plating fluid circulation port, the first flow-rate control valve provided in the first plating fluid circulation channel communicates with the first plating fluid circulation port.

9. The plating system according to claim 1, wherein the member to be plated has a plurality of blind holes, openings on one side of the blind holes being opened and openings on the other side of the same being closed, and is disposed in the closed plating cup such that the opened openings of the blind holes are in contact with the circulating plating fluid, and the surface of the member, including interior surfaces of the blind holes, is plated.

10. The plating system according to claim 1, wherein the member to be plated is a semiconductor wafer; the semiconductor wafer has a plurality of via holes, openings on one side of the via holes being opened and openings on the other side of the same being closed; the member is disposed in the closed plating cup such that the opened openings of the via holes are in contact with the circulating plating fluid, and the surface of the member, including interior surfaces of the via holes, is plated.

11. The plating system according to claim 1, wherein the member to be plated is a printed board; the semiconductor wafer has a plurality of through holes, openings on one side of the through holes being opened and openings on the other side of the same being closed; the member is disposed in the closed plating cup such that the opened openings of the through holes are in contact with the circulating plating fluid, and the surface of the member, including interior surfaces of the through holes, is plated.
